(19) United States
(12) Patent Application Publication
(10) Pub. No.: US 2001/0003316 A1
(43) Pub. Date: Jun. 14, 2001

(54) Mechanical hammer for sculptors

(76) Inventor: Vittorio Bertolla, Carrara Ms (IT)

Correspondence Address: THE BILICKI LAW FIRM, P.C., Furniture Mart Bldg. , Ste. 1000, 111 West Second Street, Jamestown, NY, 14701, US

(21) Appl. No.: 09/732,666

(22) Filed: Dec. 8, 2000

(30) Foreign Application Priority Data
Dec. 10, 1999 (EP) EP 99830766.0

(51) Int. Cl. B25D 11/00

(52) U.S. Cl. 173/205; 173/122

(57) ABSTRACT

A mechanical hammer for sculptors, comprising a body (1) suitable for being handled, a striking element (5) that slidingly engages in the body (1); a tool (6) releasably engaging with a first end of said striking element (5) accessible from the exterior of the body (1); a rotating element (10) that pivotally engages in the body (1) having a first end connected to rotating drive means located at the exterior of the body (1); cooperating means provided at the second end of the striking element (5) and of the rotating element (10), both inside the body (1), for transforming the rotating motion of the rotating element (10) into a reciprocating motion of the striking element (5) under to load through the tool (6). It is possible (7, 7a, 20) to adjust the position of maximum approaching between the striking element (5) and the rotating element (10) and the corresponding mutual matching of the cooperating means, which are in the form of a cam (18) on the striking element (5) or on the rotating element and a plurality of balls (14) for rolling on the rotating element (10) or on the striking element (5). The hammer for sculptors, being mechanical, has not the drawback of the pneumatic hammers and can easily handled and at the same time can be used for roughing out or for finishing the stone.

### FIELD OF THE INVENTION

The present invention relates to stone material cutting and more precisely it relates to a hammer to be used by workers in this field and by sculptors.

### DESCRIPTION OF THE PRIOR ART

The use of pneumatic hammers is common in building as well as in the shops where marble, stone, granite are worked and particularly in artistic workshops, such as schools of art, academies and shops wherein sculpture is taught and exercised.

Pneumatic hammers, which have been used in building for a long time, are now being used also by sculptors. In particular, besides medium sized pneumatic hammers which are suitable also for other purposes, pneumatic hammers of small and very small size are used by sculptors.

The drawbacks of pneumatic hammers are known, among which the most relevant are:

high energy consumption, owing to the double conversion from electric to mechanic and then to pneumatic power;

high air losses, which increase the energy consumption;

need of a compressor, which normally is noisy, bulky and expensive;

uncomfort generated by the air current that blows against the worker, in particular in the cold season.

Mechanical percussion devices are also known with a tool that can be used also for stone working.

However, such devices are not suitable at the same time for roughing out and for finishing the stone.

### SUMMARY OF THE INVENTION

It is therefore object of the present invention to provide a hammer for sculptors that is mechanically driven and that has not the drawbacks of pneumatic hammers as above described.

It is another object of the present invention to provide a mechanical hammer for sculptors that can be handled easily and is suitable for both roughing out and finishing stone.

These and other objects are achieved by the mechanical hammer for sculptors according to the present invention, whose characteristic is that it comprises:

a body suitable for being handled,

a striking element that slidingly reciprocates in the body;

a tool releasably engaging in a first end of the striking element accessible from the exterior of the body;

a rotating element that pivotally engages in the body having a first end integral to rotating drive means located at the exterior of the body;

cooperating means provided at the second end of both the striking element and the rotating element, which are located inside the body, for transforming the rotating motion of the rotating element into a reciprocating motion of the striking element which carries the loads of the cutting tool.

Preferably, means are provided for adjusting the position of maximum approaching between the striking element and the rotating element and then for adjusting the corresponding mutual matching of the cooperating means.

The cooperating means can comprise cam means on the striking element and a plurality of balls on the rotating element suitable for rolling on the cam means or, alternatively, cam means on the rotating element and a plurality of balls on the striking element for rolling on the cam means.

In an advantageous embodiment of the invention, the means for adjusting the position of maximum approaching of the striking element to the rotating element comprises a push button which can be operated from the outside of the body and a slotted housing made longitudinally on the striking element, the position of the slotted housing being such that the push button operates a pin that engages with the slotted housing and abuts against an end of the slotted housing, so that a further approaching of the striking element to the rotating element is prevented. Means are provided for a resilient back stroke of the push button in a rest position in which the pin is disengaged from the slotted housing, whereby when the push button is pushed the tool has a finishing movement, whereas when the push button is released the tool has a roughing out movement.

Advantageously, said body comprises a head in which said striking element engages, said head being connected to the body by means of screw coupling with the interposition of shims, the addition or the removal of said shims modifying the stroke of said finishing movement when the push button is pushed.

Always advantageously, means can be provided for locking the push button in the finishing position.

The cam means can comprise a circular flat surface from which a diametrical crest protrudes, the plurality of balls rolling in housings from which they protrude for less than half of their diameter towards said cam means, the relative rotation of the cam means with respect to the balls causing the collision of said balls against the crest and a relative axial movement for allowing the balls to pass the crest.

If the balls are on the rotating element, the housing of the balls can be a diametrical transversal hole made distant from the end face of the rotating element less than the diameter of the hole, whereby the hole is also a groove from which the balls protrude on the end face of the rotating element facing towards the cam. This way, by the centrifugal force generated by the rotating element, the balls contact the both the walls of the hole and the inner walls of the body, and load both on the walls of the hole and on those of the body the vibrations caused by the cam when hitting the balls same.

Owing to this preferred configuration, the finishing movement is obtained by adjusting the stroke of relative interference of the crest with respect to the balls, whereas the movement of roughing out is obtained by means of free approach of the crest within the balls, proportional to the force applied to the tool.

The rotating element is advantageously brought into rotation by motor means, in the form of a flexible cable contained and guided by a flexible tube, the cable being connected at the other end to a portable motor. Advantageously, in the motor a fan is provided that blows air in said tube and reaches the inner part of said body, said rotating element and said striking element being provided with cooling channels supplied with said aria.

In a preferred embodiment the sliding of the striking element in the body is advantageously guided by a groove made in said body in which needle rollers engage pivotally connected to the striking element, whereby there is a minimal sliding friction at high operating frequency.

### BRIEF DESCRIPTION OF THE DRAWINGS

Further characteristics and/or advantages of the mechanical hammer according to the present invention will be made clearer with the following description of an embodiment thereof, exemplifying but not limitative, with reference to attached drawings wherein:

FIG. 1 shows a view from the outside of the mechanical hammer for sculptors according to the invention;

FIG. 2 shows a cross sectional longitudinal view of the mechanical hammer for sculptors of FIG. 1;

FIG. 3 shows a perspective partial view of the cam coupling means for converting a rotational motion into a reciprocating motion under load of the mechanical hammer for sculptors of FIGS. 1 and 2;

FIGS. 4 and 5 show a partial longitudinal sectional view of the mechanical hammer for sculptors of FIG. 2 respectively in a finishing and a roughing out position.

### DESCRIPTION OF THE PREFERRED EMBODIMENTS

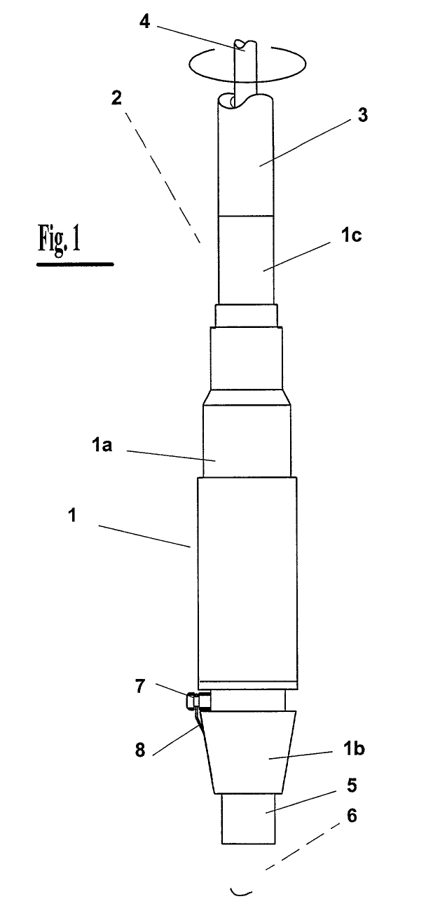

With reference to FIG. 1, a mechanical hammer for sculptors has a substantially cylindrical shape and has a body 1 having a zone 2 with a diameter suitable for being easily handled and carried with the use of one hand. Body 1 has a central portion 1a to which at opposite sides a head 1b and a sleeve 1c of support for a flexible tube 3, which contains a flexible rotating cable 4, are connected. Head 1b slidingly houses a striking element 5 suitable for releasably receiving a tool 6. Striking element 5 can slide in head 1b of body 1, but cannot rotate. In head 1b furthermore a push button 7 is housed, with an opposing spring 8. Push button 7 is used, as hereinafter described, for shifting selectively the hammer between a roughing out or finishing way.

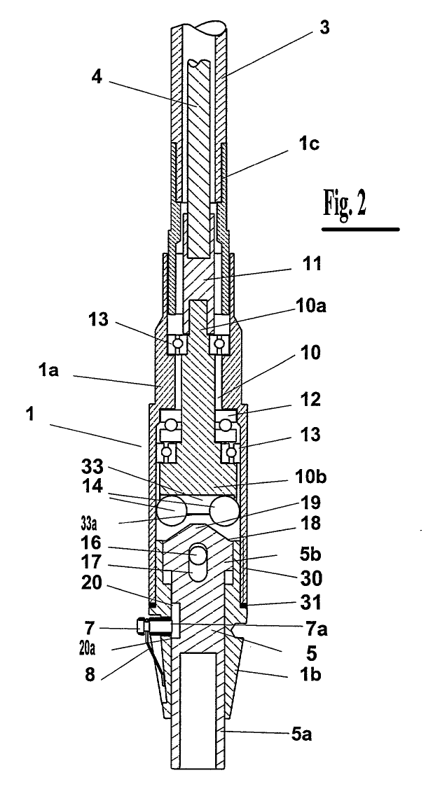

With reference to FIG. 2, the body that can be handled 1 comprises an inner rotating element 10, or rotor, connected at a first end 10a through a joint 11 to flexible rotating cable 4. Rotor 10 is pivotally connected to body 1 by means of thrust bearing 12 and radial bearing 13 and has the other end 10b housing a couple of balls 14.

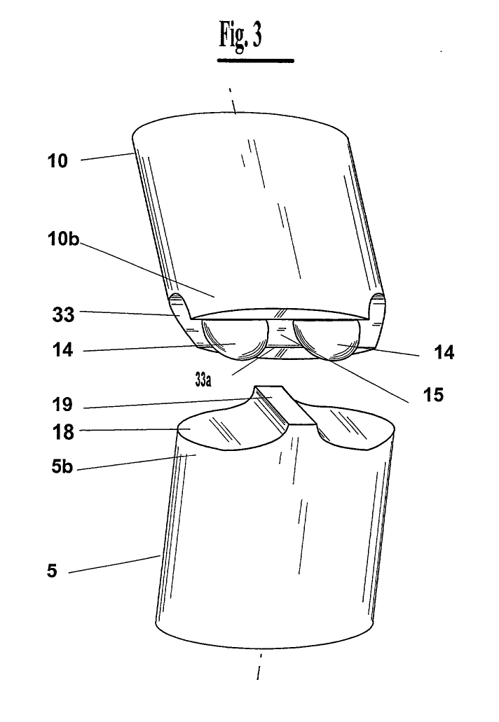

Balls 14 are arranged diametrically distanced in order to have (FIG. 3) between them an interspace 15. Furthermore, they rotatably engage with housings executed in rotor 10 from which they protrude less than half of their diameter, in order to not fall during the assembling steps and in order to have a precise location during the operation of the mechanical hammer.

The striking element 5, in turn, has a first end 5a suitable for housing the fastening end of the tool 6, and another end 5b, inner to body 1, which slides in head 1b and cannot rotate for the presence of a guiding pin 16 that slides in a guide 17. Striking element 5 has also a cam 18 having a crest 19, that extends transversally and diametrically with respect to striking element 5 same, on its face end 5b that is in front of balls 14.

As shown in FIGS. 6, the guiding pin 16 can be formed by needle rollers 16a and 16b, separated by a ball 16c. Grooves 17a and 17b allow the rolling of needle rollers 16a and 16b during the reciprocation of the striking element in head 1b of body 1. Needle rollers 16a and 16b can rotate either opposite to each other with the same speed depending on which side groove 17a or 17b they touch. This way there is a minimal sliding friction at high reciprocation frequency.

The rotation of rotor 10 causes the relative rotation of cam 18 with respect to balls 14 causing their collision against crest 19 and a relative axial movement of striking element 5 for allowing balls 14 to pass the crest 19. More precisely, under axial load of striking element 5, owing to the pressure of the tool against the stone material to be worked, 14 at every turn of rotor 10there is a penetration of crest 19 in the space 15 between balls.

As shown also in FIG. 3, the housing of balls 14 can in particular be a diametrical transversal hole 33 made in rotor 10 distant from face 10b less than the diameter of the hole same. This way the hole 33 is also a groove 33a from which the balls protrude. This way (FIG. 2), owing to the centrifugal force on the rotating element, balls 14 contact both the walls of hole 33 and the inner walls of body 1, and load the vibrations caused by the cam 18,19 created when hitting the balls same both on the walls of hole 33 and on those of body 1.

In condition of free movement of the striking element 5, the penetration of crest 19 in the space 15 is given by the force with which the mechanical hammer is pushed against the material to work. The rotation of rotor 10 is carried out normally at a frequency of 2800-3000 turns per minute. Then, a striking force is obtained proportional to the force with which the mechanical hammer is pushed, that is the a greater is this force, the longer is the stroke of the striking element.

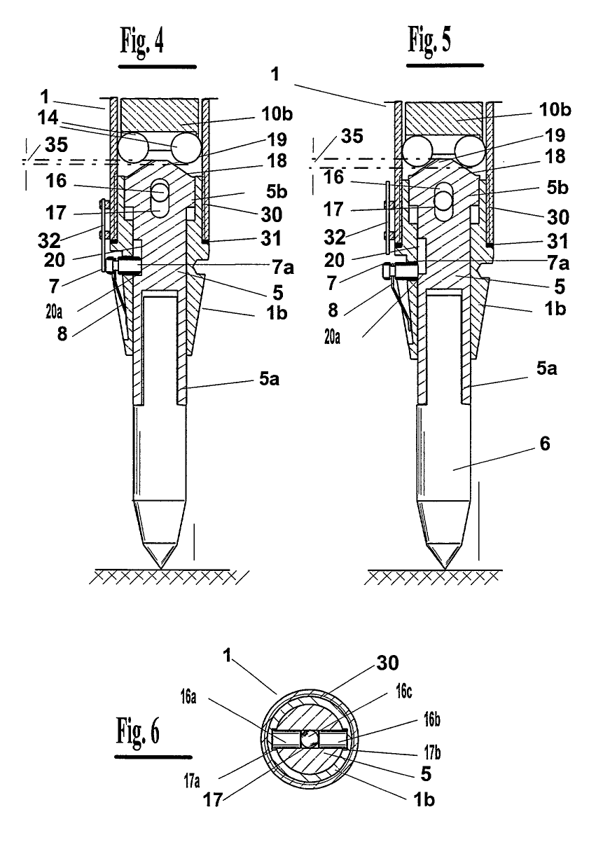

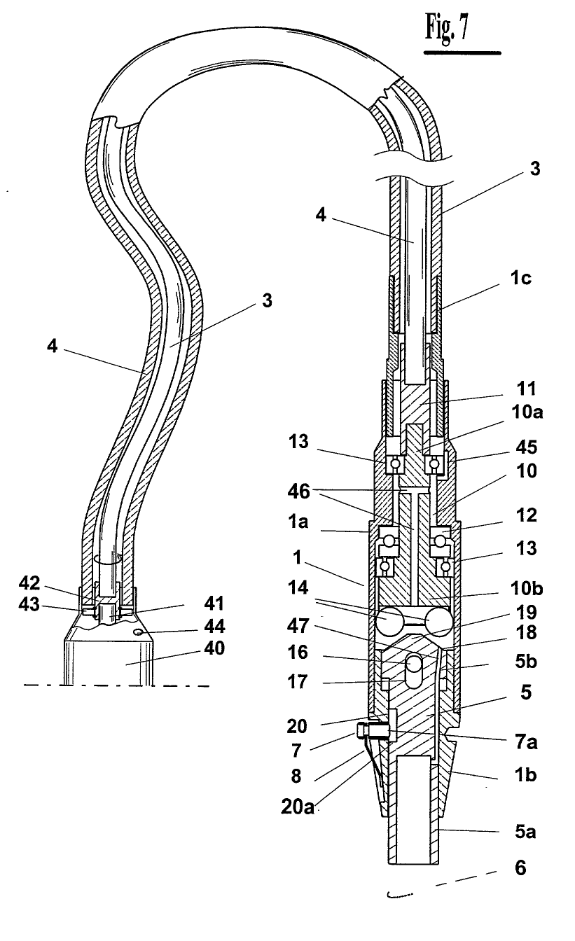

As shown in FIGS. 4 and 5, for limitating the position of maximum approaching between striking element 5 and rotor 10, and then for adjusting the corresponding mutual matching between balls 14 and crest 19, a push button 7 is provided which can be operated from the outside of body 1 and a slotted housing 20 is made longitudinally on the striking element 5.

The position of the slotted housing 20 is such that by pushing push button 7 it operates a pin 7a that engages with the slotted housing 20 and abuts with the end 20a thereof to avoid a further approaching of striking element 5 to rotating element 10.

Spring 8 allows a resiliently loaded back stroke of push button 7 to a rest position in which pin 7a is disengaged from the slotted housing 20. This way, when push button 7 is pushed the tool has a finishing movement and when push button 7 released the tool has a roughing out movement.

This allows the remarkable advantage of freely pressing the mechanical hammer with force or gently against the material to be worked without controlling the stroke of the tool, which is always limited at the minimum because of the minimum penetration of crest 19 between balls 14 owing the position of pin 7a in slotted housing 20, which prevents striking element 5 to further moving back.

Owing to this physical aspect of the present invention, the finishing movement of the mechanical hammer is obtained by means of an easy control of the stroke of relative interference 35 (FIG. 4) of crest 19 with respect to balls 14 obtained with the simple pressure with a finger on push button 7, at wish of the sculptor or of the operator.

On the contrary, the movement of roughing out is obtained by means of free penetration 35 (FIG. 5) of crest 19 with respect to balls 14, proportional to the force applied to the tool, without and the operator does any movement to obtain this, except from releasing push button 7.

All the above is advantageous for the sculptor that can to alternate operations of roughing out of finishing with the preferred frequency and without wasting time, without disconnecting if not except form an instant the tool from the stone.

Head 1b in which striking element 5 engages is connected to body 1a by means of coupling screw 30 with the interposition of shims 31. The addition or the removal of the shims changes the stroke of the finishing movement when button 7 is pushed, increasing or limiting the maximum penetration 35 of FIG. 4.

As shown in FIGS. 4 and 5, can also being provided a lock 32 for blocking push button 7 in the finishing position of FIG. 4, and whose back movement allows push button 7 of go back to the roughing out position of FIG. 5.

With reference to FIGS. 7, rotor 10 is brought into rotation by a portable motor 40 that operates flexible cable 4 contained and guided by flexible tube 3. Cable 3 is connected to the end shaft 41 of portable motor 40 by means of a joint 42. According to a preferred physical aspect of the invention, to end shaft 41 a fan 43 is keyed that sucks air through holes 44 made in the motor and blows it into tube 4 up to reaching the inner room of body 1.

Always as shown in FIGS. 7, body 1, rotor 10 and striking element 5 are provided respectively with cooling channels 45, 46, 47 supplied with the air propelled by fan 43. This way, cool air is supplied continuously and without additional costs or apparatus and can reaches the striking element and the tool, cooling them.

Holes 44 and channels 45 can also be used for conveying lubricant oil.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. Mechanical hammer for sculptors, comprising
a body (1) suitable for being handled,
a striking element (5) that slidingly engages in said body (1);
a tool (6) releasably engaging with a first end of said striking element (5) accessible from the exterior of said body (1);
a rotating element (10) that pivotally engages in said body (1) having a first end connected to rotating drive means located at the exterior of the body (1);
cooperating means provided at the second ends of said striking element (5) and of said rotating element (10), both inside the body (1), for transforming the rotating motion of said rotating element (10) into a reciprocating motion of said striking element (5) under load through said tool (6),
means (7, 7a, 20) for adjusting the position of maximum approaching between said striking element (5) and said rotating element (10) and the corresponding mutual matching of said cooperating means.

2. Mechanical hammer for sculptors according to claim 1, wherein said cooperating means comprise cam means (18) on said striking element (5) and a plurality of balls (14) for a rolling engagement of said rotating element (10) on said cam means (18), or said cooperating means comprise cam means (18) on said rotating element (10) and a plurality of balls (14) for a rolling engagement of said striking element (5) on said cam means (18).

3. Mechanical hammer according to claim 2, wherein said cam means (18) of said cooperating means comprise a circular flat surface from which a diametrical crest (19) protrudes, said plurality of balls (14) rollingly engaging in housings (33a) from which they protrude for less than half of their diameter, the relative rotation of said cam means (18) with respect to said balls (14) causing the collision of said balls (14) against said crest (19) and a relative axial movement for allowing said balls (14) to pass said crest (19).

4. Mechanical hammer according to claim 3, wherein said balls (14) are two and are arranged on said rotating element (10), said housings (33a) comprising a diametrical transversal hole (33) made in the rotating element (10) distant from the face of the rotating element (10) less than the diameter of the hole (33), whereby said hole is also a groove from which the balls protrude (14) made on the face of the rotating element (10) in front of the cam (18).

5. Mechanical hammer according to claim 2, wherein said striking element (5) has two ways of movement, consisting in a finishing movement obtained by adjusting the stroke of relative interference of said crest (19) with respect to said balls (14), and a roughing out movement obtained with a free penetration of said crest (19) with respect to said balls (14) proportional to the force applied to said tool (6).

6. Mechanical hammer for sculptors according to claim 1, wherein said means for adjusting the position of maximum approaching of said striking element (5) to said rotating element comprises a push button (7) which can be operated from the outside of said body (1) and a slotted housing (20) longitudinally made in said striking element (5), the position of said slotted housing (20) being such that by pushing said push button (7) it operates a pin (7a) that engages in said slotted housing (20) and abuts at an end of said slotted housing (20) to prevent said striking element (5) from further approaching to said rotating element, means being provided for a resilient back stroke of said push button (7) in a rest position in which said pin (7a) is disengaged from said slotted housing (20), whereby when said button (7) is pushed said tool (6) has a finishing movement and when said push button (7) is released said tool (6) has a roughing out movement.

7. Mechanical hammer according to claim 5, wherein said body (1) comprises a head (1b) in which said striking element engages (5), said head (1b) being connected to the body (1) by means of a coupling screw (30) with the interposition of shims (31), the addition or the removal of said shims (31) modifying the stroke of said finishing movement when said button (7) is pushed.

8. Mechanical hammer according to claim 1, wherein said rotating element (10) is brought into rotation by drive means in the form of a flexible cable (3) contained and guided by a flexible tube (4), the cable (3) being connected at the other end to a portable motor (40), in said motor a fan (43) being provided that blows air in said tube (4) and reaches the inner room of said body (1) which, together with said rotating element (10) and said striking element (5), comprises cooling channels (45, 46, 47) supplied with said air.

9. Mechanical hammer according to claim 1, wherein the sliding of said striking element (5) in the body (1) is advantageously guided by grooves (17a, 17b) made in said body (1) in which needle rollers engage (16a, 16b) pivotally connected (17) to said striking element (5), whereby there is a minimal sliding friction at high frequency.
